(19) United States
(12) Patent Application Publication
(10) Pub. No.: US 2006/0070842 A1
(43) Pub. Date: Apr. 6, 2006

(54) Vending machine tracking system with controlled switching device

(75) Inventor: Jim Darling, Toronto (CA)

Correspondence Address: DIMOCK STRATTON LLP, 20 QUEEN STREET WEST SUITE 3202, BOX 102, TORONTO, ON, M5H 3R3, CA

(73) Assignee: SmartMech Corporation, Brighton (CA)

(21) Appl. No.: 11/237,672

(22) Filed: Sep. 29, 2005

(30) Foreign Application Priority Data
Sep. 29, 2004 (CA) 2,483,076
Jan. 24, 2005 (CA) 2,493,837

(51) Int. Cl. G07F 9/08; G06M 1/27

(52) U.S. Cl. 194/219

(57) ABSTRACT

A tracking system counts events in the operation of multiple machines or devices over a wide geographic area. One or more reed switches for transmitting an electrical signal to a tracking device is mounted to the stationary frame of the coin mechanism and actuated by a magnetic element mounted to the revolving coin carrier. In one embodiment a controller is programmed to pass a pulse from the reed switch to a counter only once during every preset interval, for example five seconds. This helps to defeats attempts to artificially increase the vend count by jiggling the handle at the point where the magnet passes the reed switch, to cause multiple passes within a single rotational cycle of the coin mechanism. Additional prevention is provided in a further embodiment having two reed switches that must be actuated in sequence before the controller will pass a pulse to the counter.

### FIELD OF THE INVENTION

This invention relates to vending machines. In particular, this invention relates to a system for tracking merchandise vended from a vending machine.

### BACKGROUND OF THE INVENTION

Bulk venders, colloquially known as “gum ball machines”, are widely used for dispensing confectioneries and other small articles of merchandise. A typical bulk vender has a hopper assembly comprising a transparent globe which functions as a merchandise storage bin, seated over a dispensing wheel which revolves in a hopper. A patron deposits the required coinage into the coin mechanism and turns the handle, which rotates the dispensing wheel to convey a preset amount of merchandise to the dispensing chute. The hopper assembly is located over a body which is mounted on a base, defining a secure compartment containing a cash box into which the coin mechanism ejects the deposited coins.

Bulk venders are typically purchased and maintained by vender operators, who install and service the venders at high traffic locations such as shopping malls, restaurants and the like. The operator periodically restocks the venders and collects the proceeds from the sale of articles dispensed by the venders, and typically remits a portion of the proceeds to the owner of the premises. A large vender operator may operate many hundreds of bulk venders, employing service personnel to service the venders and deliver the coins which have accumulated within the cash box to the operator.

Bulk venders are intended particularly for use in unsupervised public areas, and as such are designed to resist tampering, theft and vandalism by patrons. However, since in a conventional bulk vender the number of articles dispensed from each vender is not monitored, so that the vender operator can never know how many coins should be collected from any particular vender during a service call, the operator is highly vulnerable to the theft of coins by the operator's service personnel. The operator can also be vulnerable to the substitution of slugs for coins by service personnel before the collected coins are delivered to the operator.

In either case the operator's proceeds can be significantly reduced. This significantly limits an operator's ability to expand his or her business because the operator is either limited to using only employees known to be trustworthy, or runs the risk of substantial losses due to skimming by employees. Further, this reduces the operator's ability to account to the owner of the premises on which a vender is located, because the operator can never be certain when remitting a portion of the proceeds to the owner of the premises that all monies collected by the vender have been accounted for.

Systems which track the number of vends from a bulk vender are known. However, any system for tracking the number of vends is defeated when a sufficient number of false vends is registered to eliminate the reliability of the count. Unscrupulous service personnel skimming coins from the cash box may therefore try to defeat the counting mechanism, for example by jiggling the handle at the point where the mechanism counts a vend in order to artificially increase the vend count and render it unreliable. The tolerances of the coin mechanism itself can also lead to inadvertent false vend counts.

It would accordingly be advantageous to provide a tracking system for a bulk vender having a security feature by which only actual vends are counted, i.e. the prospect of a false vend is substantially reduced or eliminated, to thus provide a consistently reliable count.

### SUMMARY OF THE INVENTION

The present invention overcomes these disadvantages by providing a tracking system for any coin-operated machine or device, including for example bulk venders. In the preferred embodiment the system of the invention counts each vend responsive to a cycle of the coin mechanism, and records the date and time of each vend.

The invention accomplishes this by providing an active tag, in the form of a microchip disposed in a housing, which has a memory for storing data representing a vending event, for example the date and time of the event. The data is periodically read by a hand-held reader or “interrogator,” which downloads the data stored in the tag memory and erases the memory to reset the tag for continued monitoring of the vender. With this information an operator can reconcile the number of coins collected from the vender with the number of vends recorded, to ensure that the operator's proceeds are not being stolen by employees. The presence of the tag would inhibit theft to such an extent that an operator would no longer have to limit the expansion of his or her business because a much greater pool of potential employees becomes available to the operator, which significantly increases the number of venders that the operator can service.

The recorded information also allows an operator to determine when the vender is likely to need restocking, to thereby anticipate servicing requirements; to track when vends take place and over what period of time, to help in determining the commercial viability of a vender location; and to track the work habits of service personnel and determine their operating efficiency.

In the preferred embodiment the tag transmits the data via a radio frequency (RF) signal, has a unique identification code, and operates responsive to a digital key which allows only a reader having a corresponding key to task the tag for data and erase its memory. Thus, the tag not only monitors the activity of the coin-operated machine or device, but also provides an instant indication as to the identity of the owner/operator.

The tag may comprise, or be a component of, a “microelectromechanical system” or “MEMS.” Such a device is capable of providing a tag identification function, data memory, mechanical power generation and storage, RF communications, coin sensing/vend actuation, and event capture where the event may be a vend, a temperature or moisture alarm, etc., and data transfer.

In a further preferred embodiment the interrogator can be provided with wireless communications capabilities and/or a GPS or GSM transponder, allowing the operator to track the whereabouts of service personnel.

In one embodiment a reed switch for transmitting an electrical signal to a tracking tag is mounted to the stationary frame of the coin mechanism and actuated by a magnetic element mounted to the revolving coin carrier. According to the invention a controller is provided that is programmed to pass a pulse from the reed switch to the tracking device only once during every preset interval, for example five seconds. This largely defeats attempts to artificially increase the vend count by jiggling the handle at the point where the magnet passes the reed switch, to cause multiple passes within a single rotational cycle of the coin mechanism, because too much time is required to increase the vend count to the point where the count would be considered unreliable. In a further embodiment a pair of reed switches is provide and each must be actuated in succession with a null in between in order to increment the vend count.

### BRIEF DESCRIPTION OF THE DRAWINGS

In drawings which illustrate by way of example only a preferred embodiment of the invention,

FIG. 1 is a perspective view of a bulk vender embodying the invention.

FIG. 2 is a rear perspective view of a coin mechanism embodying the invention in a bulk vender.

FIG. 3 is a rear elevation of the cover plate of the coin mechanism of FIG. 2.

FIG. 4 is a rear perspective view of a coin mechanism embodying a further embodiment of a switch system in accordance with the invention.

FIG. 5 is a rear elevation of the cover plate of the coin mechanism of FIG. 4.

FIG. 6 is a circuit diagram of the switch system of FIG. 4.

FIG. 7 is a timing diagram showing the normal operation of the switch system of FIG. 6.

FIG. 8 is a timing diagram showing the operation of the switch system of FIG. 6 where the switch is repetitively actuated.

### DETAILED DESCRIPTION OF THE INVENTION

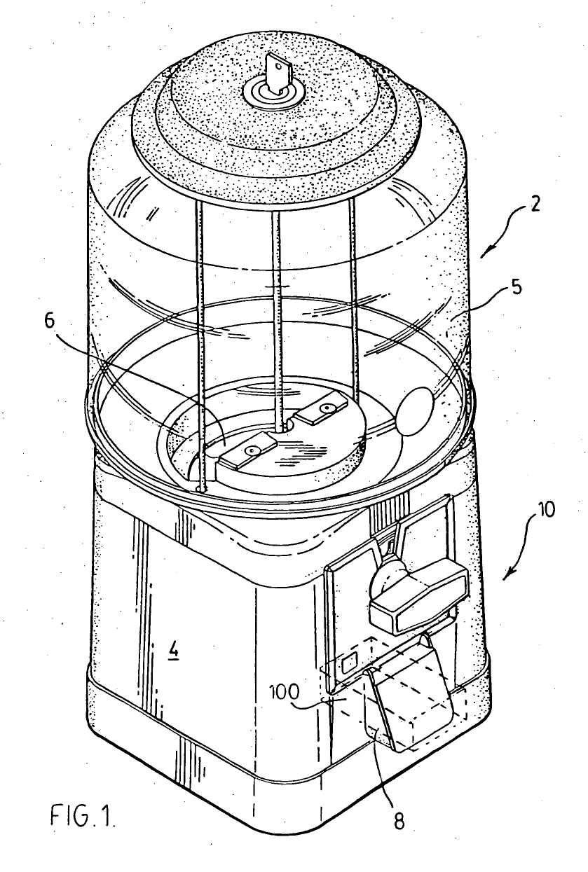

FIG. 1 illustrates a typical bulk vender 2 in which the system of the invention may be employed. The vender 2 conventionally includes a lower housing 4 enclosing the workings of the coin mechanism 10 and a cash box (not shown) for collecting deposited coins or tokens 1, a transparent article storage bin 5 for storing merchandise such as gum balls or other articles to be dispensed, and a turntable 6 which is rotated by rotation of the coin mechanism 10 to align one of a plurality of product conveyors with the opening to a dispensing chute 8, as is well known.

A vender of this type is described and illustrated in U.S. Pat. No. 5,954,181 for a “Coin Mechanism with Magnetic Locking System” issued on Sep. 21, 1999, which is incorporated herein by reference. It will be appreciated that this is merely one example of a bulk vender in which the invention can be implemented, and the description thereof is not intended to be limiting. A vending machine tracking system in which the present invention may be implemented is shown and described in the applicant's international patent application for a “Vending Machine Tracking System” published on Aug. 28, 2003 under Publication No. WO 03/071496 A2, which is incorporated herein by reference. It will be appreciated that this is merely one example of a vending machine tracking system in which the invention can be implemented, and the description thereof is not intended to be limiting.

Although the invention will be described with reference to a coin, the term “coin” as used herein includes coins and tokens and like elements, and is in no way restricted to currency or coins having a monetary value. Further, while the invention is described herein in the context of a coin mechanism 10 in a bulk vender 2, it will also be understood that a coin mechanism of the invention may be used in any other machine or device which operates responsive to a coin mechanism, including many types of machines and devices which do not dispense merchandise such as parking meters, laundry machines and video games, by way of non-limiting example, and the invention is accordingly not restricted to any particular type or application of the coin mechanism. The invention is advantageously implemented where multiple machines or devices are placed in locations that do not provide ready access to a mains electrical power supply, and are spread out over a wide geographic area, bulk venders 2 being merely one example.

In each vending machine or device 2 a complete cycle of the coin mechanism is referred to herein as a “vend,” whether the coin mechanism cycle causes merchandise to be dispensed, time on a parking meter to increase, a washing machine to complete a wash cycle, a video game to go into play mode, or otherwise.

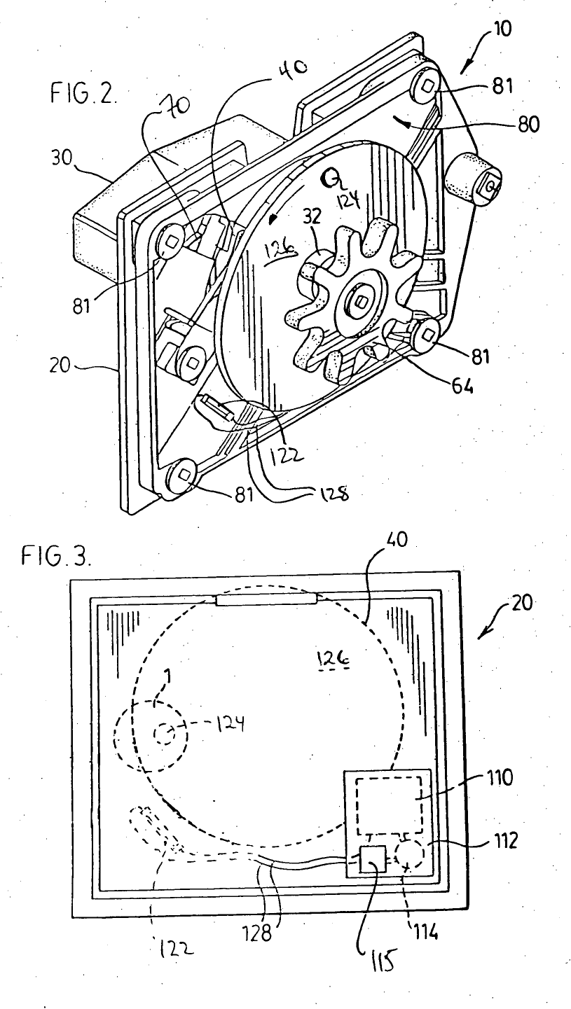

FIGS. 2 and 3 illustrate a preferred embodiment of a coin mechanism 10 embodying the invention in a bulk vender 2. The mechanism 10 comprises a cover plate 20 having a coin opening 24. A handle 30 is fixed to a tapered shaft 32 which extends through an opening formed by a nipple 26 projecting from the cover plate 20 and engages an opening 38 disposed through the centre of a substantially disc-shaped coin conveyor 40. The shaft 32 has a longitudinal flat (or slightly concave) surface 32a allowing it to rotationally engage the coin conveyor 40.

The coin conveyor 40 includes a coin receiving portion for receiving a coin 1 which comprises a recess 42 formed to the size of the intended coin 1, in which the coin 1 nests as it is conveyed about the rotational cycle of the coin mechanism 10. In the illustrated embodiment the coin conveyor 40 is provided with peripheral ratchet teeth 41 which cooperate with a pawl to prevent reverse rotation of the mechanism 10 during most of the rotational cycle (a small radius of reverse rotation is permitted immediately beyond the rest position, which allows the coin conveyor 40 to revert to the rest position if the measuring devices reject the deposited coin).

A back plate 80 overlays the coin conveyor 40 and is affixed to the cover plate 20 so as to be stationary relative thereto, as by bolts 81. The back plate 80 retains a coin 1 in the coin recess 42 along the rotational path followed by the coin 1 as the handle 30 is rotated. The shaft 32 extends through an opening 86 in the back plate 80 and is rotationally engaged to a dispensing gear 64 for rotating the turntable 6. Thus, the cover plate 20 and back plate 80 remain stationary, while the coin conveyor 40 and gear 64 are fixed in position on the shaft 32 and rotate as the handle 30 is turned.

A dog 70 for measuring the thickness of a coin 1 may be mounted on the back plate 80 biased against the coin recess 42 by a spring 70a, to catch the trailing edge of the coin recess 42 if a deposited coin or slug is thinner than the intended coin 1 and arrest rotation of the mechanism 10. Conventionally a diameter measuring dog 34 for measuring the diameter of the coin 1 is pivotally mounted on the cover plate 20, biased against the coin conveyor 40 by a spring 34a, to catch on the trailing corner 35 of the coin recess 42 if a deposited coin or slug has a diameter smaller than the intended coin 1 and thus arrest rotation of the mechanism 10. The coin conveyor 40 thus conveys the proper coin 1 to the coin ejection ramp 25, where it falls into a coin tray (not shown) concealed within the vender housing 4, along a specific rotational path that allows the measuring dog 34 to measure the coin 1 at the designated radial position. If a deposited coin or slug is not of the correct size, the dog 34 cooperates with the coin conveyor 40 to arrest rotation of the mechanism 10.

According to the invention, a tag is provided to record vending events. The tag may be a radio frequency identification (RF ID) tag 110, which comprises a ROM containing a non-erasable identification code and at least one digital key, along with any necessary operating software; an RF transceiver for receiving instructions from a reader or “interrogator” 100 (shown in phantom in FIG. 1) and transmitting data to the interrogator 100; a clock; and a RAM for erasably storing vending activity data, in the preferred embodiment representing the date and time of each complete revolution of the coin mechanism 10, and optionally the type of merchandise with which the vender 2 is stocked, and the temperature and/or humidity of the environment in which the vender 2 is located; all integrated into a single chip. Such RF ID tags are commercially available for use with electronic devices, for example for recording temperature measurements from an electronic thermometer or thermostat. An example of a suitable tag 100, without limitation, is any tag operating at 13.56 MHz and meeting the ISO 18000-3/15693 protocol or similar protocols.

In the preferred embodiment, the tag 110 is hermetically sealed in a housing 112 along with a power source 114, for example a commercially available compact lithium battery, and a controller 115, as shown in FIG. 3. The battery 114 may operate at an output of a few microamps and a voltage at or below 3.3 V, which is sufficient to operate the tag 110. The tag 110 is preferably disposed between the cover plate 20 and back plate 80, positioned so that the tag transceiver is capable of communicating with the interrogator 100 positioned in front of the coin mechanism 10, as shown in FIG. 1. If necessary the portion of the cover plate 20 overlaying the tag 110 can be reduced in thickness, or a non-metallic insert can be affixed into the cover 20 over the tag 110, to create an RF “window” which allows the tag transceiver to communicate with the interrogator 100.

The RF signal from the tag 110 should be kept at a fairly low power, to conserve energy and ensure that if venders are in close proximity to one another, data is being retrieved only from the vender being interrogated. Thus, the interrogator 100 must be held fairly close to (for example, within 10 cm), or in contact with, the cover plate 20 of the coin mechanism 10. The interrogator 100 may comprise a standard Personal Digital Assistant (PDA) that provides a port for connecting an accessory reader, and the software (which may be programmed over any standard operating platform) can be downloaded to the PDA or provided in an accessory card. Suitable PDA and other reading devices are currently available.

According to the invention, an interface 120 is provided to recognize the motion of the coin mechanism turning through a complete cycle—which is representative of a single vending event—and generate a pulse which incrementally increases the vend count in the tag 110 and preferably records the date and time of the vending event. In one preferred embodiment shown in FIG. 3, the interface 120 comprises a magnetically actuated switch, for example a reed switch 122, mounted in a stationary position on the coin mechanism frame (for example the back plate 80 as shown), cooperating with a magnet 124 embedded in or otherwise attached to a part of the coin mechanism 10 that rotates when the handle 30 is turned, for example a non-ferrous wheel 126, or the coin carrier 40 or any other convenient portion of the coin mechanism 10 that rotates when the handle 30 is turned. The reed switch 122 is connected via wires 128 to the controller 115, which may for example be a microcontroller or application specific integrated circuit (ASIC) programmed with a “debalance instruction.” The controller 115 thus senses electrical pulses from the reed switch 122 as the magnet 124 passes during the rotational cycle of the coin mechanism 10, but passes only a single electrical pulse to the tag 110 during each preset interval (as programmed into the controller 115), for example five seconds. It will be appreciated that the tag 110 and the controller 115 could be separate components or integrated into a single component.

Alternatively, the interface 120 may comprise a proximity sensor actuated by a density differential, reflective surface or other proximity actuator on the coin conveyor 40; or some other activating interface which closes a circuit to generate a pulse on the event input pin of the tag 110. In each case the interface 120 operates at a position in the rotational cycle of the coin mechanism 10 at which the coin has already been accepted, as apparent from the relative positions of the coin 1, the reed switch 122 and the magnet 124 shown in phantom in FIG. 3, so that the tag 110 does not falsely count partial rotations through the free-turning portion of the beginning of the coin mechanism cycle as actual vends. Moreover, in each case the controller is equipped with a debalance instruction that limits the number of pulses sent to the tag 110 to a single pusle during each preset interval (e.g. five seconds).

In operation, the vender 2 is set up in the selected location and the storage bin 5 is stocked with merchandise. The interrogator 110 is positioned as shown in FIG. 1, and activated to signal the tag 110 to switch out of ‘sleep’ (power saving) mode and transmit its identification code. If this is the first interrogation, the interrogator 100 is initialized to the tag 110, i.e. the operator key stored in ROM in the tag 110 is then programmed into the interrogator 100 and will thereafter be recognized by the interrogator 100. (Alternatively, the operator key can be preprogrammed into the interrogator 100 by the manufacturer as a recognized key). The identification code is retrieved by the interrogator 100 and the service person enters the location of the vender 10 into the interrogator 100 via an alpha-numeric keypad (not shown). Thereafter, each time the coin mechanism 10 is rotated through a complete cycle, the magnet 124 passes the reed switch 122 and sends an electrical pulse to the controller 15, which in turn sends an electrical pulse to the tag 110 and starts counting down the preset interval (e.g. five seconds) during which any further pulses received from the reed switch 122 are blocked by the controller 15 and never reach the tag 110. The tag 110 thus counts another single vend, and preferably associates with the vend event data representing the date and time of the vend. Accordingly, no matter what attempts are made to artificially increase the count by forcing the magnet 124 into proximity of the reed switch 122 multiple times during a single rotational cycle of the coin mechanism 10, the tag 10 will count only a single vend during each preset interval (e.g. five seconds).

Periodically, service personnel interrogate the tag 110 using the interrogator 100, and retrieve the data stored in RAM. The interrogator 100 is used to signal the tag 110 to switch out of ‘sleep’ mode and transmit its identification code. If the operator key is recognized by the interrogator 100, the identification code is retrieved by the interrogator 100 along with the data representing vend events, which may include the date and time of a vend, and if desired a code representing the type of merchandise being dispensed. When the data retrieval is complete, the interrogator 100 signals the tag 110 to erase its RAM and return to the ‘sleep’ mode.

After collecting data from a number of venders on a route, the data stored in the interrogator 100 is downloaded to a data collection system including a computer, for example a desktop or laptop PC (not shown), for review and analysis. The interrogator 100 may be placed into a cradle or otherwise docked directly to the computer (via cable, infrared, RF or otherwise), or the interrogator or its cradle may be provided with or connected to a modem for a dial-up connection to the computer.

In one embodiment the tag 110 is intended to be disposable. A currently-available lithium battery can last up to five years. Upon battery failure, or other failure of the tag 110, the tag 110 would be discarded and replaced with a new tag 110. Although tags are commercially available which transmit at intervals, in the preferred embodiment the tag 110 transmits only when switched out of sleep mode by the interrogator 100, to conserve battery life and thus prolong the life of the tag 110. In an alternative embodiment, the tag 100 is permanent and a separate battery is provided. The battery may be a rechargeable battery, which for example could be recharged by induction, or the battery be disposable and replaced when it nears the end of its expected life. The tag 110 may also comprise or be a component of a “microelectromechanical system” or “MEMS,” having the tag identification function, data memory, mechanical power generation and storage, RF communications, coin sensing/vend actuation, and event capture as described herein. In either case the tag 110 is preferably capable of being powered by induction from the electromagnetic field generated by the interrogator 100, which also allows the interrogator 100 to effect data transfer from the tag 110 without using the power supply 114, to both conserve power and ensure that data can be recovered (where the tag 110 has a non-volatile memory) if the power source 114 fails.

Preferably the tag 110 also stores in ROM a manufacturer's or “master” key, allowing the manufacturer to operate and retrieve information (such as the identification code) when it is necessary to identify the owner/operator of the vender. Additionally, preferably the manufacturer can program the interrogator 100 to recognize (or reject) the operator key for any particular tag 110, or to reset a tag 110 so that another interrogator 100 can be initialized to the tag 110, in order to facilitate an operator selling part of a route or territory to another operator.

In a further preferred embodiment the interrogator 100 can be provided with a Global Positioning System (GPS) transponder or a Global System for Mobile communications (GSM) transponder (not shown), or any other suitable wireless positioning/communications medium, which may communicate for example over a regional cellular network, or for very wide area applications by satellite, allowing the operator to track the whereabouts of service personnel servicing the venders 2. In these embodiments the interrogator 100, which can incorporate a mobile phone, can initiate communications with a central station at predetermined intervals, or can be tasked by the central station to upload information at any time desired by the operator.

In other applications, for example for tracking revenues and other events relating to taxicabs, the device of the invention can be connected to existing counting circuitry to record events as they occur, and can upload information at desired intervals to a central station or administrator in like fashion or read by an interrogator 100 when the taxi physically returns to the central station.

The tag 110 may utilize volatile memory, in which power must be constantly applied in order for the tag to retain the data in memory. In an alternative preferred embodiment, the tag 110 comprises a non-volatile memory, for example as may be found in current EPROM, EEPROM, and FLASH technologies, which do not require a battery 114 permanently connected to the tag 110. In the latter embodiment the battery 114 may be disconnected entirely from the tag 10 whenever the switching interface 120 breaks the circuit to the tag counter input, and is reconnected by the switching interface 120 closing or the interrogator 100 tasking the tag 110 out of sleep mode. Thus, any type of memory (semiconductor, magnetic, and others), whether it retains information in the absence of applied power or requires the constant application of power, can be used in the invention.

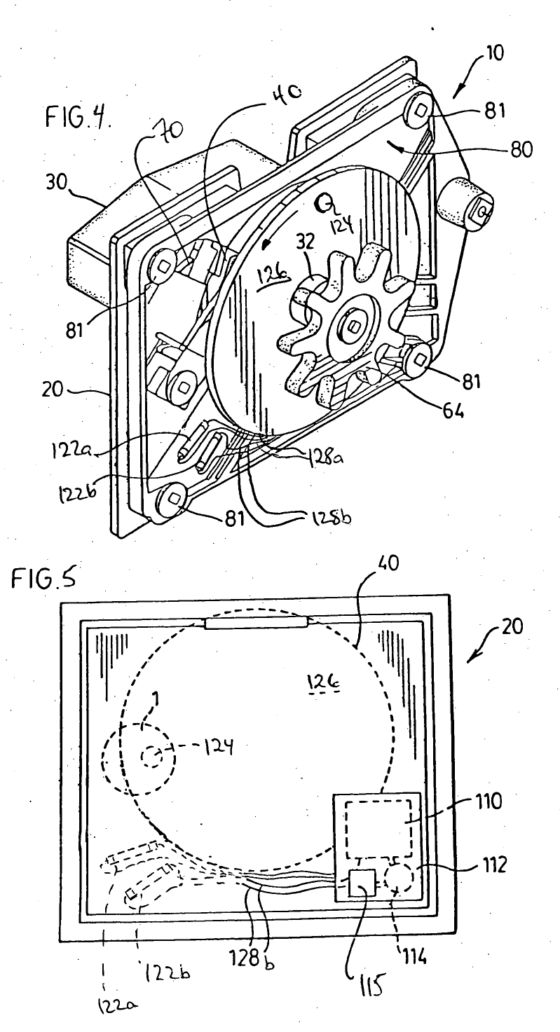

Certain types of coin mechanisms, due to lower tolerances and/or the provision of spring loaded parts, can be more vulnerable to attempts to falsely increase the vend count by repetitive actuation of the switch mechanism, and in some cases merely rotating the coin mechanism causes vibrations that repetitively actuate the reed switch and cause the tracking system count to increase falsely. To provide a further means for preventing this, the invention contemplates a dual-switch switching mechanism, illustrated in FIGS. 4 and 5. In this embodiment two normally open reed switches 122a, 122b are mounted in a stationary position on the coin mechanism back plate 80, both cooperating with a magnet 124 attached to a rotating part of the coin mechanism 10, for example a non-ferrous wheel 126 as shown. The second reed switch 122b is mounted downstream of the first reed switch 122a relative to a rotational direction of the coin mechanism 10. The reed switches 122a, 122b are respectively connected in parallel to the controller 115 via wires 128a, 128b.

In this embodiment the controller 115 preferably comprises an analog-to-digital converter (ADC), which allows the controller 115 to detect analog signals. This is advantageous both for the operation of this embodiment of the invention, as described below, as well as to allow the controller 115 to sense the battery voltage (and therefore its depletion state) and to measure temperature, if desired.

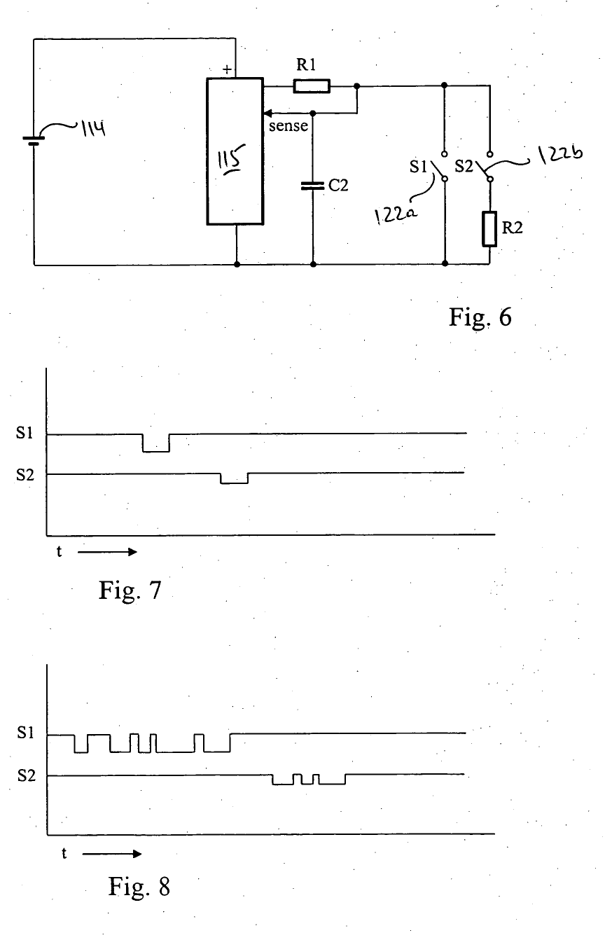

In the preferred embodiment the controller 115 sends a signal to the tag 100 to increment the count only in response to a complete count-increment sequence representing actuation of the first switch 122a, deactivation of the first switch 122a, and after a null interval, actuation of the second switch 122b. Thus, preferably the second reed switch 122b is spaced far enough from the first reed switch 122a that the magnet 124 can influence only one switch at a time. As illustrated in FIG. 6, a sensing circuit feeds a signal to the controller 115. The sensing circuit may comprise a capacitor C1, which dampens fluctuations caused by repetitive actuation of either of the switches 122a, 122b. When the magnet 124 moves into proximity of the first reed switch 122a, the first switch 122a is closed and the sensed voltage drops to zero (common), powered by pullup resistor R1. As the magnet 124 moves out of proximity of the first switch 122a, the first switch 122a is opened and the sensed voltage goes high. When the magnet 124 moves into proximity of the second reed switch 122b, the second switch 122b is closed, but because of series resistor R2 the sensed voltage drops to an intermediate voltage above zero. The ADC detects the non-zero voltage and can distinguish it from both the high and low states, to thus trigger the counter to increment the vend count by 1.

FIG. 7 illustrates a timing diagram for the embodiment of the switching mechanism illustrated in FIGS. 4 and 5. Actuation of the first switch 122a (S1) pulls the voltage down to zero, then the voltage returns to high as the magnet 124 passes and its magnetic field ceases influencing the switch 122a. There is a null interval during which the signal remains high, followed by actuation of the second switch 122b, which drops the voltage partway to zero. The controller 115 is programmed to increase the counter only upon sensing the complete sequence of low signal, high signal and intermediate signal (the latter being detectable by the ADC in the controller 115), representing the complete increment-count sequence of assertion of the first switch 122a, both switches 122a, 122b open, and then assertion of the second switch 122b.

FIG. 8 illustrates a timing diagram for the case where the switches 122a, 122b are repetitively actuated, either by a user trying to deliberately trigger a false count or where the characteristics of the coin mechanism 10 are such that inherent vibrations cause repetitive actuation of the switches 122a, 122b. Here there are many low intervals in the signal as switch 122a is repetitively actuated, but the controller 115 does not increment the count until the first intermediate signal drop occurs when the second switch 122b is closed. The controller 115 then immediately resets the increment-count subroutine, so the further intermediate signal drops caused by repetitive actuation of the switch 122b are ignored, as the controller 115 now requires a fully low signal (i.e. closure of the first switch 122a) to start the increment-count sequence.

It is advantageous to have actuation of the first switch 122a cause voltage drop all the way to zero, since this can be used by the controller 115 to sense a digital low signal without using the ADC component, and can thus be used to take the controller 115 out of sleep (battery-conserving) mode.

Note that instead of using one or more normally open reed switches actuated by a magnet 124 passing in proximity of the reed switches, the embodiments of the invention can alternatively be implemented using one or more normally closed reed switches that remain in proximity of a stationary magnet 124, and having a magnetically permeable member rotate with the coin mechanism 10 and pass close enough to the magnet to draw the magnetic field away from the reed switch(es) and thus actuate the reed switch(es). This embodiment of the invention otherwise operates as in the previous embodiments.

In the preferred embodiment the controller 115 is also programmed to detect when either switch 122a, 122b is actuated for an undue interval, for example when a user stops turning the coin mechanism 10 at a point where one or the other of the switches 122a, 122b is held open. To conserve power in this situation, the controller 115 after a designated interval removes power from the switches 122a, 122b. The controller 115 reapplies power to the switches 122a, 122b periodically, to see if the switches 122a, 122b have both opened, and continues to remove power from the switches 122a, 122b until it has detected that the switches 122a, 122b are both open.

A preferred embodiment of the invention has been described by way of non-limiting example only. Those skilled in the art will appreciate that certain modifications and adaptations may be made without departing from the scope of the invention as claimed.

I claim:

1. A switching system for a tracking device for a coin mechanism that registers a vend when an electrical pulse is received by the tracking device, comprising
a power supply,
a first magnetically actuated switch mounted in stationary relation to a frame of the coin mechanism, for selectively transmitting an electrical pulse from the power supply to the tracking device when the first switch is closed,
a second magnetically actuated switch mounted in stationary relation to a frame of the coin mechanism downstream of the first switch relative to a rotational direction of the coin mechanism, for selectively delivering an electrical pulse from the power supply to the tracking device when the second switch is closed,
a magnetic element for actuating the switches, mounted to a portion of the coin mechanism that revolves as a handle of the coin carrier is turned, and
the tracking device comprising a controller for receiving electrical pulses from the switches and responsive to receiving electrical pulses in a count-increment sequence from the first switch and then from the second switch selectively delivering a single electrical pulse to a counter to increment a count,
whereby once the controller delivers a pulse to the counter the controller does not deliver a further pulse to the counter until the controller detects another count-increment sequence.

2. The switching system of claim 1 wherein the second switch is spaced far enough from the first switch that the magnetic element can influence only one switch at a time.

3. The switching system of claim 2 wherein the count-increment sequence further comprises detecting a null interval between detecting a signal from the first switch and detecting a signal from the second switch.

4. The switching system of claim 1 wherein the signal delivered by closing the first switch is at a different voltage than the signal delivered by closing the second switch.

5. A method of incrementing a count in a tracking device for a coin mechanism that registers a vend when an electrical pulse is received by the tracking device, having switching system, comprising the steps of
a. closing a first switch to selectively deliver a first electrical pulse from the power supply to the tracking device,
b. closing a second switch to selectively deliver a second electrical pulse from the power supply to the tracking device, and
c. in response to receiving electrical pulses in a count-increment sequence, selectively delivering a single electrical pulse to a counter to increment a count.

6. The method of claim 5 wherein the count-increment sequence further comprises a null interval between the pulse delivered in step a. and the pulse delivered in step b.

7. The method of claim 5 wherein the pulse delivered in step a. is at a different voltage than the pulse delivered in step b.
